(19) United States
(12) Patent Application Publication
(10) Pub. No.: US 2008/0227450 A1
(43) Pub. Date: Sep. 18, 2008

(54) Indoor call control apparatus associated with public mobile network

(75) Inventors: Norihisa Matsumoto, Fuchu (JP); Hitomi Nakamura, Kokubunji (JP); Nodoka Mimura, Hachioji (JP); Takashi Sakai, Fujisawa (JP)

Correspondence Address: Stanley P. Fisher;Reed Smith LLP, Suite 1400, 3110 Fairview Park Drive, Falls Church, VA, 22042-4503, US

(73) Assignee: Hitachi Communication Technologies, Ltd.

(21) Appl. No.: 12/010,695

(22) Filed: Jan. 29, 2008

(30) Foreign Application Priority Data
Mar. 16, 2007 (JP) 2007-067803

(51) Int. Cl. H04Q 7/20

(52) U.S. Cl. 455/435.1

(57) ABSTRACT

A public mobile terminal can use both of a public mobile communication service and an extension service while protecting an SIP message by an IP sec. An indoor call control apparatus that receives an INVITE message from the public mobile terminal has a destination determination table that determines whether the called terminal is an indoor terminal, or not. When the terminal is the indoor terminal, a Route header is deleted from the INVITE message, and the message is transmitted to the called terminal. When the called terminal is not the indoor terminal, the INVITE message is transmitted to an S-CSCF of a calling terminal on the basis of the contents of the Route header.

### CLAIM OF PRIORITY

The present application claims priority from Japanese application JP 2007-067803 filed on Mar. 16, 2007, the content of which is hereby incorporated by reference into this application.

### FIELD OF THE INVENTION

The present invention relates to an indoor call control apparatus that enables indoor extension transmission, indoor extension reception, transmission to a public mobile network, and reception from the public mobile network.

### BACKGROUND OF THE INVENTION

JP 2003-299157A discloses an indoor system that supplies an indoor extension service, an outgoing call service to the public mobile network, and an incoming call service from the public mobile network to a public mobile terminal within an indoor area. In the indoor system, a radio protocol used in the extension service is made common to a radio protocol for a public mobile communication. As a result, the public mobile terminal is capable of using both of the extension service and the public mobile communication service without supporting another radio protocol. When the terminal transmits a call connection request message to a radio base station, the call connection request message is transferred to the radio basis station control device, and the radio base station control device determines a called party identifier within the message. If the called party identifier is a public cellular phone Number, the radio base station control device transfers the call connection request message to a public mobile exchange, and the public mobile exchange conducts a usual public cellular phone call process. On the other hand, when the called party identifier is an extension telephone number, the radio case station control device transmits a call connection request message to PBX, and the PBX conducts an extension call process. That is, the radio base station control device between the public mobile exchange and the terminal identifies whether a request service of the terminal is the extension service or the public mobile communication service. When the request service is the extension service, the PBX transmits and receives the call control message with respect to the terminal instead of the public mobile exchange.

On the other hand, in 3GPP (3^{rd} generation partnership project) and 3GPP2 (3^{rd} generation partnership project 2) which are organizations to standardize the 3^{rd} generation cellular phone systems, the public cellular phone technology of All-IP network which is called “IMS (IP multimedia subsystem)/MMD (multimedia domain) is standardized as 3GPP TS23.228 V6.11.0 and 3GPP2 X.S0013-002-A V1.0. In the IMS/MMD, an SIP server that is called “CSCF” (call session control function) is used instead of the conventional mobile exchange as the call control device. The CSCF mainly includes S-CSCF (Serving-CSCF) and P-CSCF (proxy-CSCF). The S-CSCF manages subscriber information of the terminal, and conducts the service control of the outgoing and incoming calls. From the viewpoint of a terminal, an arbitrary terminal is controlled by exact one S-CSCF that is home of the terminal. The P-CSCF is an SIP server that directly communicates with the terminal using SIP messages, and security association with the terminal is established to protect against an access to the IMS/MMD of an unauthorized terminal. When the terminal makes a call, the terminal first transmits the call connection request message of SIP to P-CSCF, and P-CSCF transmits the call connection request message to S-CSCF of the terminal when the call connection request message is authorized.

### SUMMARY OF THE INVENTION

In order to realize an indoor system cooperated with IMS/MMD, there arise the following problems. First, the radio base station control device and PBX cannot transmit or receive the SIP message with respect to the terminal instead of P-CSCF. This is because the terminal and P-CSCF protect the SIP message by the aid of IPsec.

On the other hand, in a method of dividing S-CSCF by a user company unit and conducting extension control by S-CSCF, it is necessary to rearrange S-CSCF of the terminal that had been originally possessed by the user every time the user company introduces the indoor system or every time the user changes a belonged company.

The present invention has been made in view of the above circumstances, and therefore an object of the present invention is to provide an indoor call control apparatus that receives a call connection request message of SIP which is transmitted by an indoor terminal by the aid of IPsec, and transmits the call connection request message to a called terminal when the called terminal indicated within the message is a terminal that is located in an indoor area, and transmits the cal connection request message to S-CSCF of a calling terminal when a called terminal is not the terminal within the indoor area.

According to an aspect of the present invention, the terminal is capable of using both of the public mobile communication service and the extension service while protecting against an SIP message by IPsec.

### BRIEF DESCRIPTION OF THE DRAWINGS

FIG. 1 is a diagram showing a cellular phone system to which the present invention is applied;

FIG. 2 is a diagram showing a communication path in the case of an extension connection;

FIG. 3 is a diagram showing a communication path in the case of a connection to a terminal that is located outdoor;

FIG. 4 is a structural diagram showing an indoor call control apparatus;

FIG. 5 is a sequence diagram showing an SIP registration from an indoor area;

FIG. 6 is a diagram showing a destination determination table;

FIG. 7 is a diagram showing a format of a REGISTER message;

FIG. 8 is a flowchart showing a process of receiving a REGISTER message;

FIG. 9 is a diagram showing an outgoing sequence of the terminal;

FIG. 10 is a diagram showing a format of an INVITE message;

FIG. 11 is a flowchart showing a process of receiving the INVITE message;

FIG. 12 is a flowchart showing an indoor de-registration; and

FIG. 13 is a flowchart showing an indoor de-registration process.

### DETAILED DESCRIPTION OF THE PREFERRED EMBODIMENTS

A description will be given embodiments of the present invention with reference to the accompanying drawings.

In this embodiment, a case in which the present invention is applied to a network complying to 3GPP2 will be exemplified.

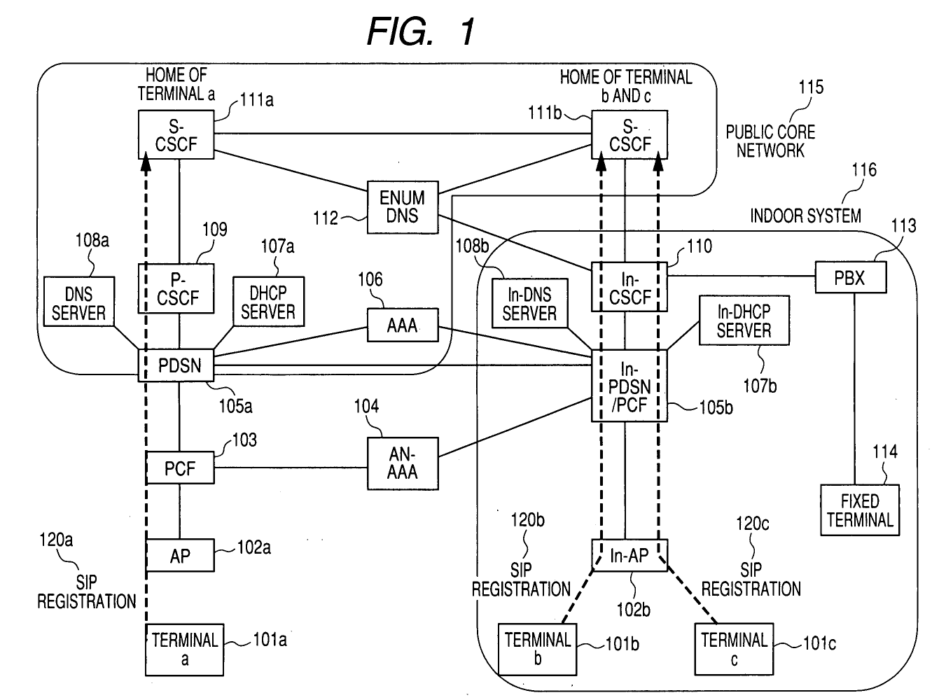

FIG. 1 is a diagram showing a cellular phone system according to an aspect of the present invention. A terminal a (101a), a terminal b (101b), and a terminal c (101c) are public radio terminals that enable a VoIP communication by cdma2000 1xEV-DO protocol. Reference AP 102a is a radio base station that conducts a radio communication. The terminal b (101b) and the terminal c (101c) cannot communicate with the AP 102a because those terminals b (101b) and c (101c) are out of a radio zone of the AP 102a. When the terminal b (101b) and the terminal c (101c) also move within the radio zone of the AP 102a, those terminals can communicate with the AP 102a. A PCF (packet control function) 103 is a device that buffers a packet addressed to the terminal a (101a) from a PDSN (packet data serving node) 105a according to a radio communication state between the terminal a (101a) and AP 102a. A PDSN 105a is a device that terminates a PPP link from the terminal a (101a), which is an access gate way to the public core network 115. An AN-AAA 104 is an authenticating device for authenticating the devices of the terminal a (101a), the terminal b (101b), and the terminal c (101c).

An AAA 106 is an authenticating device for authenticating the users of the terminal a (101a), the terminal b (101b), and the terminal c (101c). A DHCP server 107a is a device for notifying the PPP-connected terminal a (101a) of the IP address of the DNS server 108a. The DNS server 108a is a device for notifying the terminal a (101a) of the IP address of a P-CSCF 109.

The P-CSCF 109 is an SIP server that receives SIP messages from the terminal a (101a) and sends SIP messages to the terminal a (101a) in order to provide the public cellular phone service for the terminal a (101a). Upon receiving the SIP message from the terminal a (101a), the P-CSCF 109 transfers the SIP message to an S-CSCF that conducts the service control of the terminal a (101a), that is, an S-CSCF 111a of a home of the terminal a (101a). The S-CSCF 111a and 111b are SIP servers that conduct the service control of the public radio terminal. Since the S-CSCF 111a is the home of the terminal a (101a), the S-CSCF 111a permits or regulates outgoing calls and incoming calls of the terminal a (101a). Similarly, the S-CSCF 111b is a home of the terminal b (101b) and the terminal c (101c), and implements the outgoing call control and the incoming call control of those terminals on the basis of the respective subscriber information. An ENUM DNS 112 is a device that converts the dial number of the terminal into SIP URI.

When the S-CSCF 111a and 111b receive a call connection request message from the terminal, that is, the SIP INVITE message through the P-CSCF, the S-CSCF 111a and 111b access to an ENUM DNS 112 and derive the SIP URI of the called terminal. Since the S-CSCF that is the home of the called terminal can be specified from the SIP URI of the called terminal, the S-CSCF of the home of the calling terminal transmits the INVITE message to the S-CSCF of the home of the called terminal. The general public cellular phone network is configured as described above.

Subsequently, the indoor system 116 will be described. An In-AP 102b is an EV-DO radio base station that is located indoor, and wirelessly communicates with the terminal b (101b) and the terminal c (101c). When the terminal a (101a) moves within the radio zone of the In-AP 102b, the terminal a (101a) can wirelessly communicate with the In-AP 102b. An In-PDSN/PCF 105b is a device having both of the function of the PDSN 105a and the function of the PCF 103. An In-DHCP server 107b is a device that notifies the terminal b (101b) and the terminal c (101c) which are PPP-connected to the In-PDSN/PCF 105b of the IP address of the In-DNS server 108b. An In-DNS server 108b is a device that gives notice of the IP address of the In-CSCF 110 in response to an inquiry of the P-CSCF address from the terminal b (101b) and the terminal c (101c). An In-CSCF 110 is an indoor call control apparatus of the present invention. A PBX 113 calls a fixed terminal 114 in response to the call connection request from the In-CSCF.

After the terminal a (101a) establishes a PPP link with respect to the PDSN 105a, the terminal a (101a) conducts the SIP registration (120a). When the terminal a (101a) transmits the SIP REGISTER message to the P-CSCF 109, the P-CSCF 109 transfers the SIP REGISTER message to the S-CSCF 111a that is the home of the terminal a (101a). The S-CSCF 111a stores the IP address of the terminal a (101a), and notifies the P-CSCF 109 of information necessary for the IPsec that is established between the P-CSCF 109 and the terminal a (101a). The P-CSCF 109 notifies the terminal 101a of the information. After that, the terminal a (101a) and the P-CSCF 109 transmit and receive the SIP message by the aid of the IPsec. The terminal a (101a) discards the SIP message that has been transmitted by a device other than the P-CSCF 109 as an unauthorized message.

Similarly, the terminal b (101b) practices SIP registration after the terminal b (101b) establishes the PPP link with respect to the In-PDSN/PCF 105b (120b). When the terminal b (101b) transmits the SIP REGISTER message to the In-CSCF 110, the In-CSCF 111b transfers the SIP REGISTER message to the S-CSCF 111b that is the home of the terminal b (101b). The S-CSCF 111b stores the IP address of the terminal b (101b), and notifies the P-CSCF 110 of information necessary for the IPsec that is established between the P-CSCF 110 and the terminal b (101b). The In-CSCF 110 notifies the terminal 101b of the information. After that, the terminal b (101b) and the In-CSCF 110 transmit and receive the SIP message by the aid of the IPsec. The terminal b (101b) abandons the SIP message that has been transmitted by a device other than the In-CSCF 110 as an unauthorized message.

Similarly, the terminal c (101c) practices SIP registration as with the terminal b (101b) (120c).

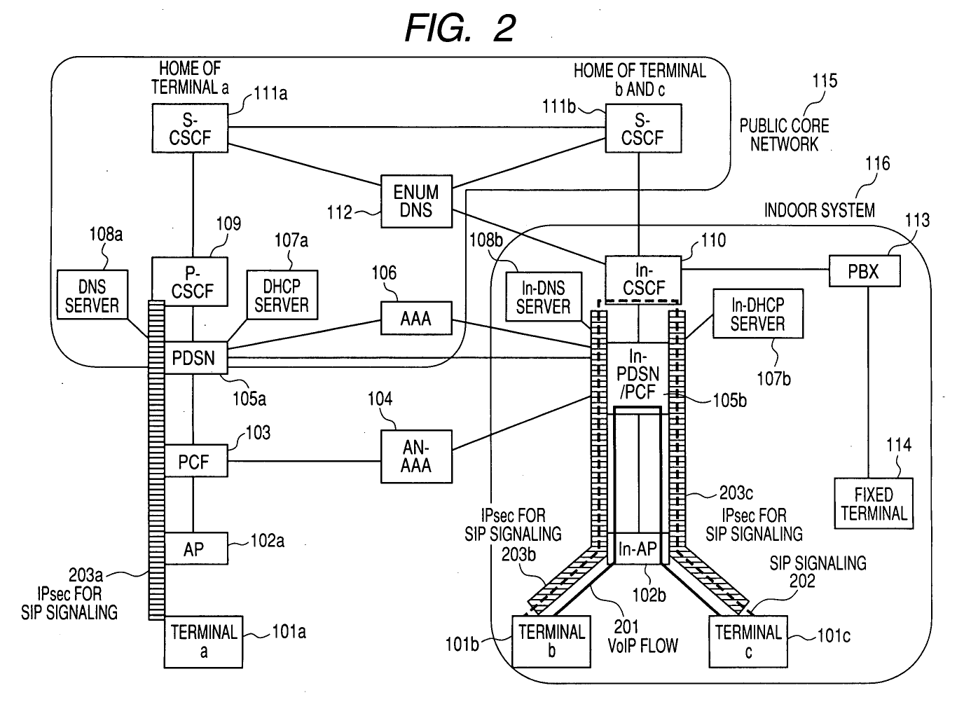

SIP registrations by the terminal a (101a), the terminal b (101b), and the terminal c (101c) bring IPsec tunnels for SIP communication 203a, 203b, and 203c as shown in FIG. 2, respectively. As a result, the terminal a (101a) receives nothing other than the SIP message from the P-CSCF 109.

Also, FIG. 2 shows a communication path in the case of the extension connection. When the terminal b (101b) calls the terminal c (101c), the SIP message is transferred to the path of the SIP signaling 202 to conduct a call connecting process. No SIP message for call connection is transferred to the S-CSCF 111b of the home of the terminal b (101b) and the terminal c (101c). This is the main feature of the present invention. The VoIP packet that is transmitted and received between the terminal b (101b) and the terminal c (101c) is transferred to the path of a VoIP flow 201. The call connection is conducted as described above, thereby making it possible to realize the extension call closed within the indoor system without giving a load to the S-CSCF 111b.

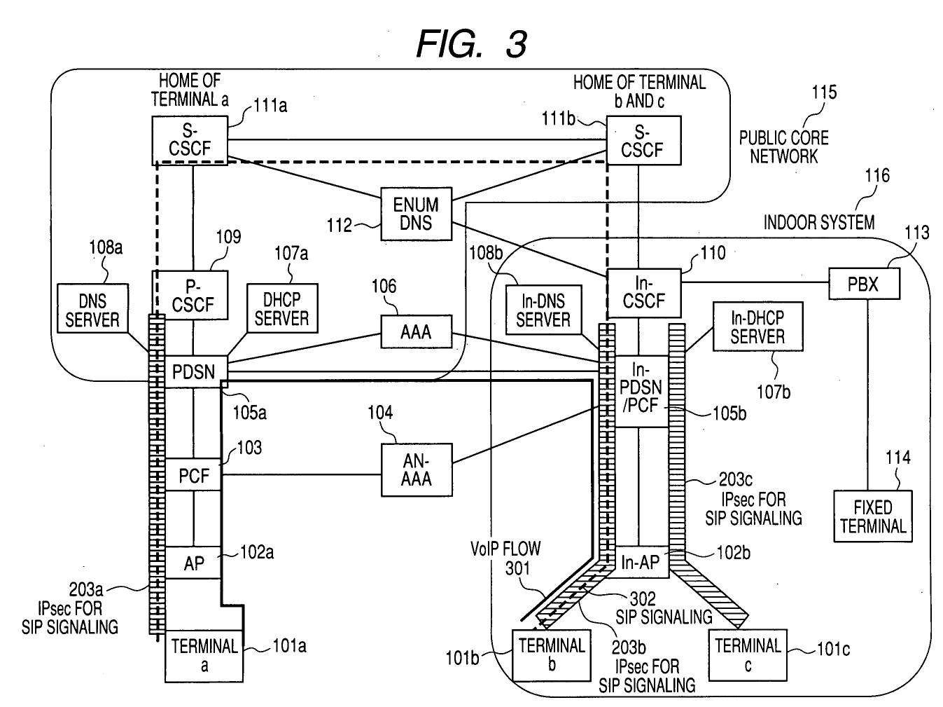

FIG. 3 shows a communication path when the terminal b (101b) calls the terminal a (101a). The SIP message is transferred to the path of an SIP signaling 302 to conduct the call connecting process. The VoIP packet that is received and transmitted between the terminal b (101b) and the terminal a (101a) is transferred to the path of a VoIP flow 301.

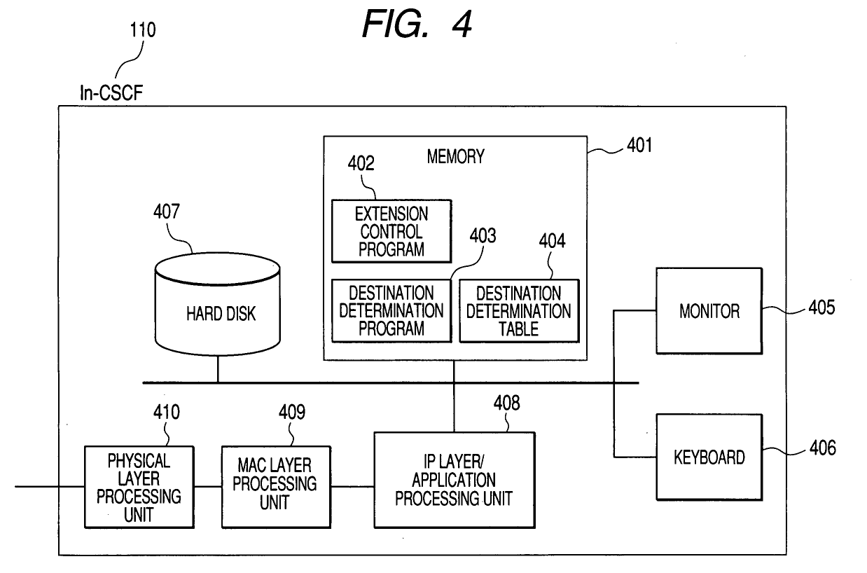

FIG. 4 is a structural diagram of the In-CSCF 110. A physical layer processing unit 410 terminates a physical layer of a communication line that is connected to a network. An MAC layer processing unit 409 terminates the MAC layer of the communication line. An IP layer/application processing unit 408 conducts the processing of the IP packet that is transmitted or received with respect to another communication device through the communication line, and the processing of the SIP message. Program and data for those processing exist on a memory 401. Also, extension control program 402, destination determination program 403, and a destination determination table 404 for realizing the present invention exist on the memory 401. The destination determination program 403 is program that determines whether the called terminal identifier of the call connection request message which has been received from the external of the device through the physical layer processing unit 410 and the MAC layer processing unit 409 is a terminal that is positioned within the indoor area, or not. The destination determination table 404 is referred to for the determination. The extension control program 402 is program for transmitting the call connection request message to the terminal to implement the call connection when the called terminal is a terminal that is positioned in the indoor area. A hard disk 407 stores program and data for implementing the IP layer/application processing unit. The program is deployed on the memory 40 when the In-CSCF 110 starts. A monitor 405 and a keyboard 406 are an output device and an input device which are used for maintenance of the In-CSCF 110 by a maintenance person.

Subsequently, how to set the destination determination table 404 in the SIP registration 120b will be described.

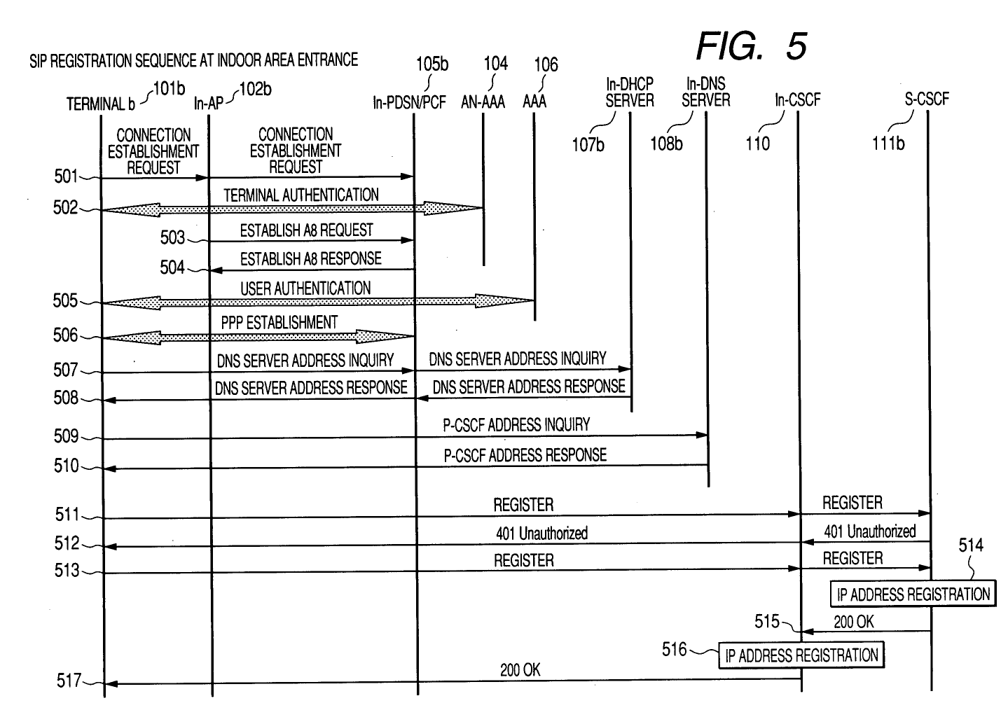

FIG. 5 shows an SIP registration sequence when the terminal b (101b) enters the indoor area.

First, terminal b (101b) transmits a connection establishment request to the In-AP 102b (Step S501). The In-AP 102b transmits the message to the In-PDSN/PCF 105b. Then, the terminal authentication is conducted between the terminal b (101b), the In-PDSN/PCF 105b, and the AN-AAA 104, respectively (Step S502). When the terminal authentication is successful, the In-AP 102b transmits an establish A8 request to the In-PDSN/PCF 105b (Step S503). The In-PDSN/PCF 105b transmits the establish A8 response to the In-AP 102b (Step S504).

With the above processing, the A8 connection between the In-AP 102b and the In-PDSN/PCF 105b is established. The A8 connection is a connection for transferring the PPP frame that is transmitted or received by the terminal b (101b) and the In-PDSN/PCF 105b.

Subsequently, the user authentication is conducted between the terminal b (101b), the In-PDSN/PCF 105b, and the AAA 106, respectively (Step S505). When the authentication is successful, the PPP link is established between the terminal b (101b) and the In-PDSN/PCF 105b (Step S506).

Then, the terminal b (101b) transmits a DHCP message for an inquiry of the DNS server address to the In-PDSN/PCF 105b (Step S507). The In-PDSN/PCF 105b transfers the received message to the In-DHCP server 107b. The In-DHCP server 107b sends a response message that stores the IP address of the In-DNS server 108b therein to the In-PDSN/PCF 105b (Step S508). The In-PDSN/PCF 105b transmits the received message to the terminal b (101b).

Subsequently, in order to solve the IP address of the P-CSCF, the terminal b (101b) transmits the DNS message of an address inquiry to the In-DNS server 108b (Step S509). The In-DNS server 108b transmits the response message having the address of the In-CSCF stored therein as the address of the P-CSCF to the terminal (Step S510). Then, the terminal b (101b) transmits the REGISTER message for SIP registration to the In-CSCF 110 (Step S511).

In this situation, since security association has not yet been established between the terminal b (101b) and the In-CSCF 110, no IPsec is used. The In-CSCF 110 adds header information indicating that no protection is made by the IPsec to the REGISTER message, and transmits the header information to the S-CSCF 111b that is the home of the terminal b (101b). The S-CSCF 111b transmits 401 unauthorized message including an authentication challenge value and an IPsec key information to the In-CSCF 110.

The In-CSCF 110 stores the IPsec key information, and transmits the 401 unauthorized message to the terminal b (101b) (Step S512). The terminal b (101b) stores the IPsec key information therein. Also, authentication calculation is conducted on the authentication challenge value, and the calculation result is set in the REGISTER message, and transmitted to the In-CSCF 110. The IPsec is used from the message transmission (Step S513). The In-CSCF 110 transmits the REGISTER message to the S-CSCF 111b.

The S-CSCF 111b stores the IP address of the terminal b (101b) therein when the authentication result in the message is correct (Step S514). Then, the S-CSCF 111b transmits a 200 OK message that indicative of the SIP registration success (Step S515). Upon receiving the 200 OK message, the In-CSCF 110 stores the IP address of the terminal b (101b) in the destination determination table (Step S516). Then, the In-CSCF 110 transmits the 200 OK message to the terminal b (101b) (Step S517). With the execution of the above registration sequence, the terminal b (101b) can perform both of the registering process for the public mobile communication service and the registering process for the indoor extension service by one SIP registration.

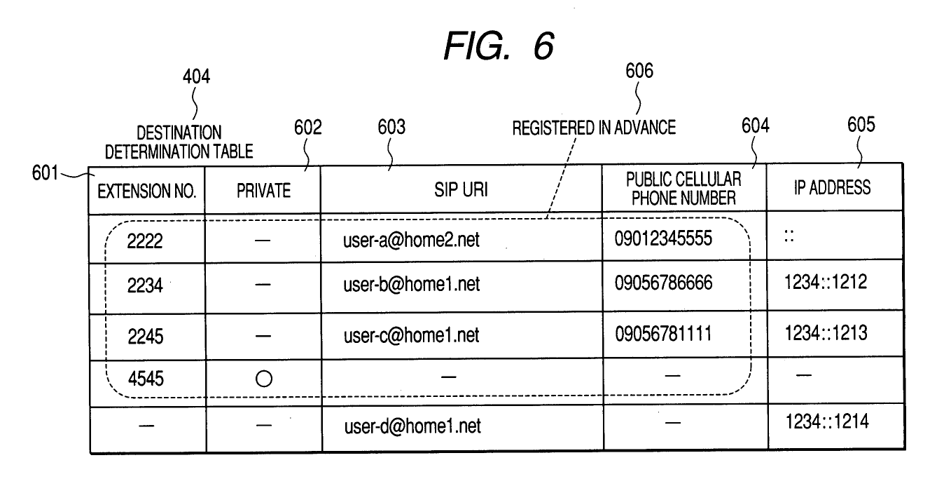

FIG. 6 shows the destination determination table. Each row of the table is a record related to one terminal. An extension number 601 indicates an extension number that is uniquely allocated to the terminal by the user company. In the figure, the extension number is not registered in the record of the lowermost row. However, the row indicates not a terminal of an employee of the user company but a general terminal that temporarily moves to the indoor area.

A private flag 602 indicates a terminal that is received in a PBX 113, that is, a record of the non-public terminal. An SIP URI 603 indicates an SIP URI of the terminal. In the figure, the IP address of the record of the uppermost row is an address of all 0. This means that the terminal is currently positioned out of the indoor area. Information that is registered by a maintenance person of the indoor system in advance is the extension number 601 of the employee terminal of the user company, the private flag 602, the SIP URI 603, and the public cellular phone number 604 (a portion indicated by reference numeral 606 in the figure).

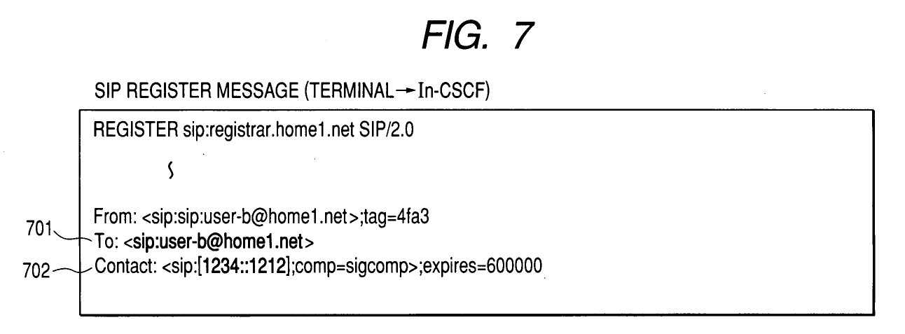

FIG. 7 shows a format of the REGISTER message that is transmitted by the terminal b (101b). A To header 701 shows the SIP URI of the terminal b (101b). Also, a Contact header 702 indicates the IP address of the terminal b (101b).

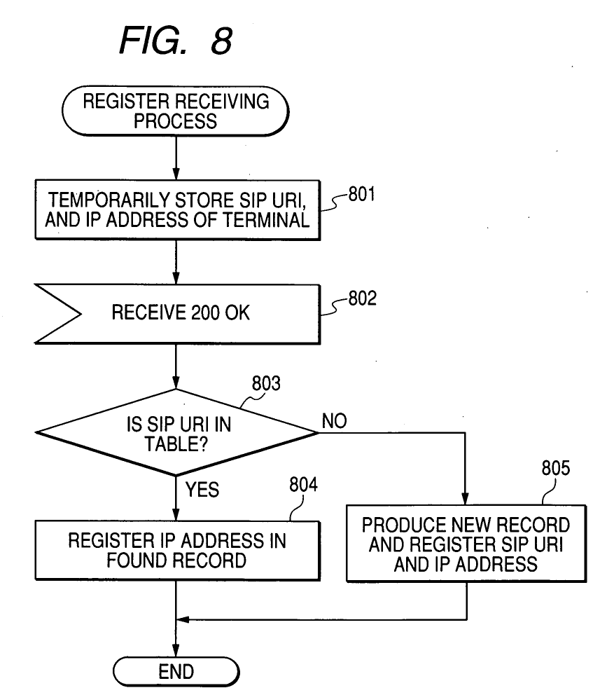

A process of receiving the REGISTER message by the In-CSCF 110 is shown in FIG. 8. First, the SIP URI and the IP address of the terminal are temporarily stored with reference to the To header and Contact header 702 (Step S801). Then, when the OK message is received from the S-CSCF 111b (Step S802), the destination determination table 404 is searched by the stored SIP URI 603 (Step S803). If the identical SIP URI 603 is found, the IP address is registered in the record (Step S804). If the identical SIP URI 603 is not found in Step S803, a new record is produced in the destination determination table, and the SIP URI and the IP address of the terminal are registered (Step S805). As a result, the general public terminal that is not registered as the extension terminal of the indoor system in advance can also receive calls from the terminal that exists in the same indoor system without giving a load to the S-CSCF.

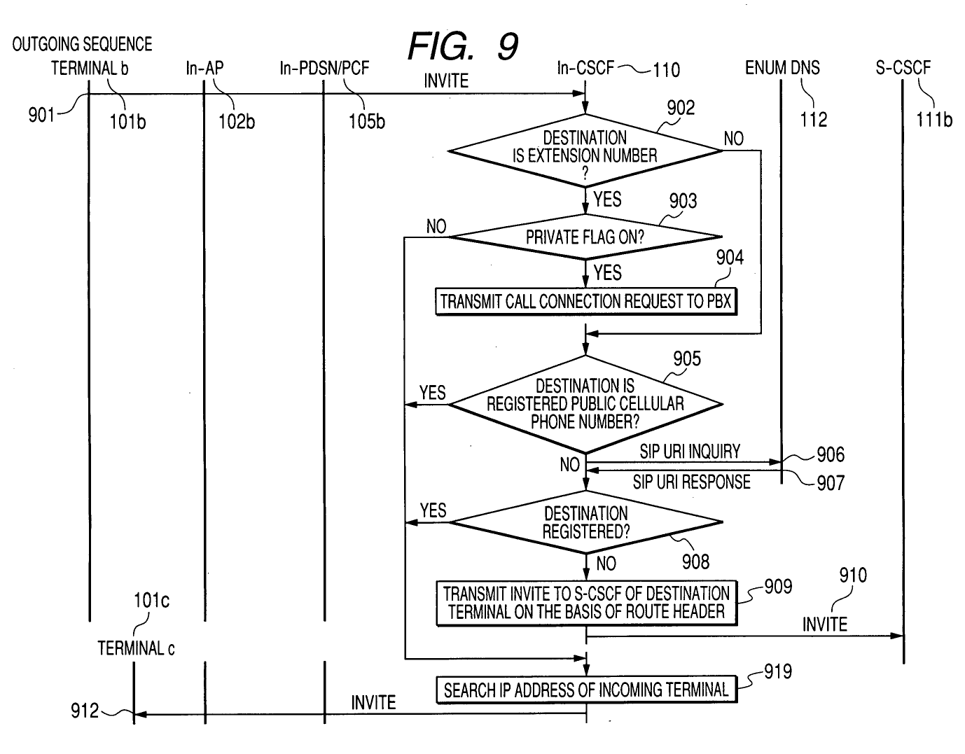

FIG. 9 shows the outgoing sequence of the terminal b (101b). First, the terminal b (101b) transmits the INVITE message indicative of the call connection request to the In-CSCF 110 (Step S901). The In-CSCF 110 searches whether the extension number 601 that is identical with the called terminal that is indicated in the message exists in the destination determination table 404, or not (Step S902). If such an extension number 601 exists in the destination determination table 404, the In-CSCF 110 determines whether the private flag 602 of the corresponding record is on, or not (Step S903). If the private flag 602 is on, the In-CSCF 110 makes a call connection request to the PBX 113 (Step S904). If the private flag 602 is not on in Step S903, the In-CSCF 110 finds the IP address of the corresponding record (Step S911), and transmits the INVITE message (Step S912). If the called terminal is not the extension number in Step S902, the In-CSCF 110 searches whether the registered public cellular number that is identical with the called terminal exists in the destination determination table 404, or not (Step S905).

If such a registered public cellular number exists in the destination determination table 404, the In-CSCF 110 finds the IP address of the corresponding record (Step S911), and transmits the INVITE message (Step S912). If such a registered public cellular number does not exist in the destination determination table 404, the In-CSCF 110 inquires about the SIP URI of the called terminal (Step S906). Upon receiving the SIP URI response (Step S907), the In-CSCF 110 searches whether the record that is identical with the received SIP URI records in the destination determination table 404, or not (Step S908). If such a record exists in the destination determination table 404, the In-CSCF 110 finds the IP address of the corresponding record (Step S911), and transmits the INVITE message (Step S912). If such a record does not exist in the destination determination table 404, the In-CSCF 110 transmits the INVITE message to the S-CSCF 111b that is the home of the terminal b (101b) (Step S910).

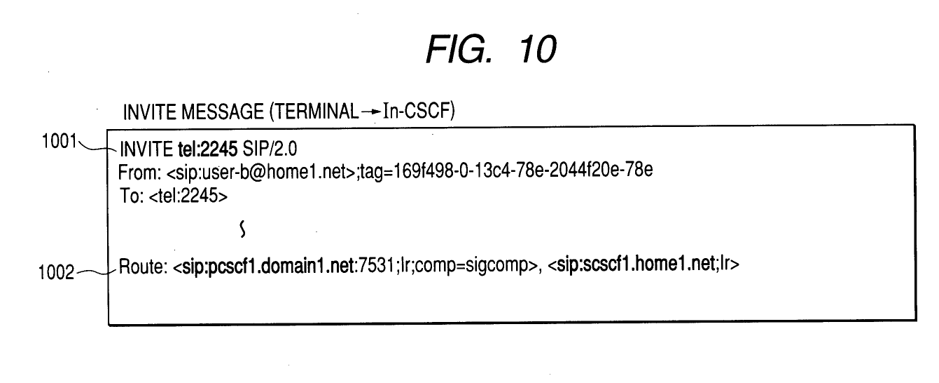

FIG. 10 shows the format of the INVITE message that is transmitted by the terminal 101b. A dial number is included in a request line 1001. In this example, the dial number is “2245”. A Route header 1002 includes the SIP URI of the In-CSCF and the S-CSCF through which the INVITE message should pass. In this example, pcscf1.domain1.net means In-CSCF 110. Also, scscf1.home1.net means the S-CSCF 111b that is the home of the terminal b (101b).

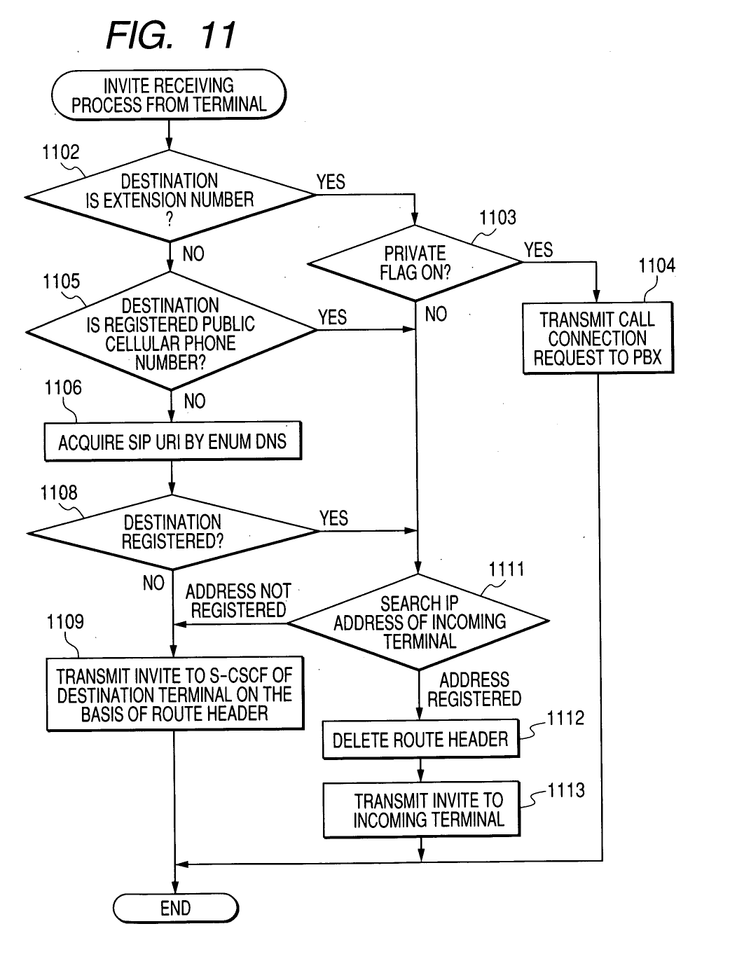

FIG. 11 shows a processing flow when the In-CSCF 110 receives the INVITE message from the terminal b (101b). First, the In-CSCF 110 searches whether the extension number that is identical with the dial number of the request line 1001 exists in the destination determination table 404, or not (Step S1102). If such a record exists in the table, the In-CSCF 110 determines whether the private flag 602 of the record is on, or not (Step S1103). If private flag 602 is on, the In-CSCF 110 makes a call connection request to the PBX 113 (Step S1104). As a result, the fixed extension terminal that is received in the PBX can receive a call. If the private flag is not on in Step S1103, the In-CSCF 110 finds the IP address 605 of the corresponding record in order that the In-CSCF 110 directly transmits the INVITE message to the called terminal (Step S1111). When the IP address is not registered, since the subject terminal does not exist within the indoor system, the processing goes on to Step S1109, and the In-CSCF 110 transmits the INVITE message to the S-CSCF of the calling terminal on the basis of the Route header in the INVITE message. On the other hand, If the IP address of the called terminal is obtained in Step S1111, the In-CSCF 110 deletes all of the Route header 1001 (Step S1112) in order to modify the INVITE message into a normal form as the INVITE message that is received by the called terminal. In the SIP protocol, the INVITE message always goes through the SIP server indicated by the Route header, and each of the SIP servers deletes the Route header indicative of the SIP server per se from the INVITE message when the INVITE message goes through the SIP server. That is, no Route header remains in the INVITE message when the INVITE message reaches the called terminal so far as the INVITE message is normally transferred through the servers. With the provision of Step S1112, the terminal of the type that determines whether the Route header remains in the INVITE message, or not, can receive a call.

In the processing of the called terminal, If reception is conducted even in the case where the Route header exists in the incoming INVITE message, Step S1112 can be omitted, and the processing of the In-CSCF can be reduced. After Step S1112, the In-CSCF 110 transmits the INVITE message to the IP address that is found in Step S1112 (Step S1113). As a result, the In-CSCF 110 can call the called terminal that exists within the indoor system without transmitting the INVITE message to the S-CSCF. If the extension number that is identical with the dial number does not exist in the destination determination table 404 in Step S1102, the In-CSCF 110 searches whether there is the public cellular phone number 604 that is identical with the dial number of the request line 1001, or not (Step S1105). When the identical record is found, the processing is shifted to Step S1111.

As a result, when the called terminal exists within the indoor system, the In-CSCF 110 can call the terminal without transmitting the INVITE message to the S-CSCF. If there is no identical record in Step S1105, the In-CSCF 110 inquires about the SIP URI corresponding to the dial number to the ENUM DNS 112 (Step S1106). Then, the In-CSCF 110 searches the SIP URI 603 of the destination determination table 404 (Step S1108). If the identical record is found, the processing is shifted to Step S1112. As a result, when the called terminal exists within the indoor system, the In-CSCF 110 can call the terminal without transmitting the INVITE message to the S-CSCF. If the identical record is not found in Step S1108, the In-CSCF 110 transmits the INVITE message to the S-CSCF 111b that is the home of the terminal b (101b) indicated by the Route header 1002 in order to conduct the call connection by the function of the public core network 115 (Step S1109). As a result, the In-CSCF 110 can call the terminal that exists out of the indoor system by the public cellular phone network function.

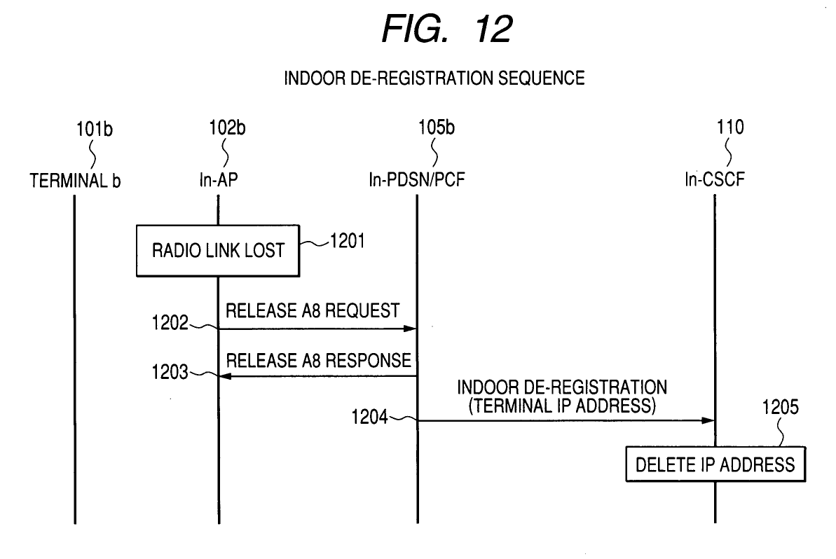

FIG. 12 shows a sequence that deletes the IP address of the terminal b (101b) that is registered in the destination determination table 404 of the In-CSCF 110 by moving the terminal b (101b) out of the indoor area. When the In-AP 102b detects that the radio link with the terminal b (101b) is lost (Step S1201), the In-AP 102b transmits the release A8 request to the In-PDSN/PCF 105b (Step S1202). The In-PDSN/PCF 105b transmits the release A8 response to the In-AP 102b, and release the A8 connection and the PPP (Step S1203). Then, the In-PDSN/PCF 105b transmits the indoor de-registration including the IP address of the terminal that release the PPP to the In-CSCF 110 (Step S1204). The In-CSCF 110 deletes the IP address that is notified from the destination determination table 404 (Step S1205). As a result, calls to the terminal that has been moved outdoors is conducted through the S-CSCF.

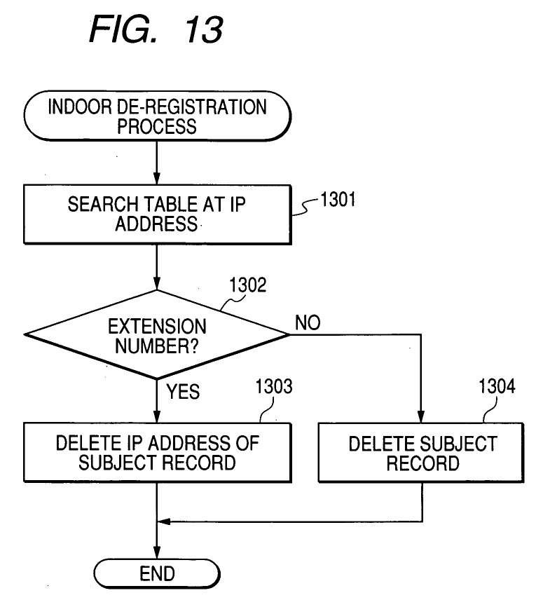

FIG. 13 is a flowchart of the indoor de-registration process of the In-CSCF 110. The In-CSCF 110 searches the IP address 605 of the destination determination table 404 by the IP address that is notified from the In-PDSN/PCF 105b (Step S1301). Then, the In-CSCF 110 determines whether the extension number 601 of the found record is registered, or not (Step S1302). If such an extension number 601 is registered, the In-CSCF 110 deletes the IP address of the subject record (Step S1303). As a result, it is possible to manage that the extension terminal exists out of the indoor system. When the extension number 601 has not been registered, the In-CSCF 110 deletes the record per se (Step S1304). As a result, the terminal information of the terminal whose extension is not registered in the indoor system in advance is held only during the terminal exists within the indoor system, and the memory resource is optimized.

In the above description, the indoor call control apparatus of the present invention has been described in combination with the radio access network of the 3GPP2. Similarly, the public cellular phone service and the extension service can be realized in combination with the radio access network of 3GPP.

What is claimed is:

1. An indoor call control apparatus, comprising:
a transmitting/receiving unit that transmits or receives a call control message with respect to a terminal and a public call control device;
a processing unit that processes the message; and
a memory unit that stores program that is executed by the processing unit,
wherein when a called terminal that is included in a call connection request message which is transmitted to the public call control device from a terminal which is positioned within an area of the indoor call control apparatus through the indoor call control apparatus is a terminal that is positioned within the area of the indoor call control apparatus, the call connection request message is transmitted to the called terminal not through the public call control device, and
wherein when the called terminal is not the terminal that is positioned within the area of the indoor call control apparatus, the call control request message is transmitted to the public call control device.

2. The indoor call control apparatus according to claim 1, wherein when the called terminal is the terminal that is positioned within the area of the indoor call control apparatus, the call connection request message is transmitted to the called terminal not according to the Route header information of the call connection request message.

3. The indoor call control apparatus according to claim 1, wherein when the called terminal is the terminal that is positioned within the area of the indoor call control apparatus, all Route headers within the call connection request message are deleted and transmitted to the called terminal.

4. The indoor call control apparatus according to claim 1,
wherein the memory unit includes a destination determination table that stores an IP address and a called terminal identifier of the terminal that is positioned within the area of the indoor call control apparatus, and
wherein when the called terminal identifier that is included in the call control request message is identical with the called terminal identifier of the destination determination table, a call control request message is transmitted to the IP address corresponding to the called terminal identifier of the destination determination table.

5. The indoor call control apparatus according to claim 3, wherein when the terminal enters the area of the indoor call control apparatus, the IP address of the terminal is registered in the destination determination table.

6. The indoor call control apparatus according to claim 4, wherein a public identifier that is used by the public call control device and the extension identifier that is defined by the indoor call control apparatus apart from the public identifier are stored in the destination determination table.

7. The indoor call control apparatus according to claim 5, wherein when the terminal registers the IP address in the public call control device through the indoor call control apparatus, the indoor call control apparatus searches the destination determination table according to the identifier of the terminal which is included in a registration completion notifying message that is transmitted from the public call control device to the terminal, and stores the IP address of the terminal in correspondence with the identifier.

8. The indoor call control apparatus according to claim 5, wherein when no identifier corresponding to the destination determination table exists, a new record is produced, and the IP address of the terminal is stored in correspondence with the identifier of the terminal.

9. The indoor call control apparatus according to claim 1, wherein when the called terminal is a nonpublic terminal that is positioned within the area of the indoor call control apparatus, the call connection request message is transmitted to the nonpublic terminal without transmitting the call connection request message to the public call control device.

10. An indoor call control system having an indoor call control apparatus that transmits or receives a call control message with respect to a terminal and a public call control device,
wherein the indoor call control apparatus comprising:
a transmitting/receiving unit that transmits or receives a call control message with respect to a terminal and a public call control device;
a processing unit that processes the message; and
a memory unit that stores program that is executed by the processing unit,
wherein when a called terminal that is included in a call connection request message which is transmitted to the public call control device from a terminal which is positioned within an area of the indoor call control apparatus through the indoor call control apparatus is a terminal that is positioned within the area of the indoor call control apparatus, the call connection request message is transmitted to the called terminal not through the public call control device, and
wherein when the called terminal is not the terminal that is positioned within the area of the indoor call control apparatus, the call control request message is transmitted to the public call control device.
